(19) United States
(12) Patent Application Publication
(10) Pub. No.: US 2017/0076410 A1
(43) Pub. Date: Mar. 16, 2017

(54) TIME CAPSULE PARK

(71) Applicant: Barry Stransky, Garden City, NY (US)

(72) Inventor: Barry Stransky, Garden City, NY (US)

(21) Appl. No.: 15/363,035

(22) Filed: Nov. 29, 2016

Related U.S. Application Data
(62) Division of application No. 14/120,566, filed on Jun. 4, 2014.

(51) Int. Cl. G06Q 50/16; G06Q 10/10

(52) U.S. Cl. CPC G06Q 50/163; G06Q 10/10

(57) ABSTRACT

A time capsule facility for storing time capsules and storing information regarding the time capsules.

### RELATED APPLICATIONS

This application is a divisional of application Ser. No. 14/120,566 filed Jun. 4, 2014.

### FIELD OF THE INVENTION

The present invention relates to a time capsule facility for storing time capsules.

### BACKGROUND OF THE INVENTION

U.S. Des. Pat. Nos. 338,329, 330,818, 338,317, 386,112 relate to a time capsule.

U.S. Pat. No. 5,312,008 relates to a time capsule for personal use comprising a hollow two part cylinder of high strength, non-corrosive, non-biodegradable plastic, means to interlock said two parts in a hermetically sealed relationship, the means including a resilient, compressible gasket member.

U.S. Pat. No. 4,665,668 relates to a personal time capsule of the preservation of artifacts over a period of hundreds of years, constructed of non corrosive high strength materials. A body containing the cavity for storage is hermetically and water tight sealed with an inner sealing member, O-rings, a gasket and a cover cap threaded to the body. A bolt is used to secure the inner sealing member and the cover cap.

U.S. Pat. No. 5,238,137 relates to a long-term storage container including a box like titanium receptacle having a titanium primary cover and sealed by a seal ring of malleable precious metal clamped between the cover and the receptacle, with titanium/ceramic valves in the cover for use in exhausting air from the receptacle and replacing it with argon gas, with titanium/precious metal back-up plugs sealing the valves after the air has been replaced. A titanium secondary cover is bonded to the receptacle by a titanium weld, reinforcing the seal by the primary cover, and has a cuttable integral metal wall, an inner titanium container is disposed in the receptacle with elongated, resiliently flexible ribs in its walls engaging similar ribs on the adjacent wall.

U.S. Patent Publication 2004/0005409 relates to a method of burial which includes collecting and containing physical remains including cremated ashes and non-cremated DNA material of a deceased person, collecting in a memory device digitized data on the biographical and medical history of the deceased person, providing a sealable time capsule to contain the physical remains and the digitized data, and providing a communication terminal on the time capsule for accessing, uploading and downloading the digitized data.

U.S. Patent Publication 2010/0121989 relates to software for recording and storing thoughts and media. It relates to a way to capture and store all parts of a life journey. The software application has a media center for storing photos, video and audio files, journal, letters for the future, capturing world headlines, photo editing center, video making center, etc.

U.S. patent publication 2010/0234981 relates to a time capsule safekeeping system comprising a controlling organization maintaining a secure registry system of data records relating to a plurality of physical time capsules and a secure storage system for a plurality of physical time capsules. Each time capsule is assigned a unique identifying code and at least one identifying device that facilitates access to the data record within an interactive computer based database and proves ownership of the time capsule. The time capsules are stored within uniquely numbered crypts at the storage facility. The system allows for the use of lower cost mass produced time capsule components.

### SUMMARY OF THE INVENTION

The present invention relates to a system of storing and keeping information on time capsules placed in a park.

The present invention relates to a facility and system for storing time capsules and keeping information on said time capsules. The time capsules are placed in a park and/or a museum. The facility provides time capsules to a user. The facility is subdivided into sections. The facility deeds the sections to users for placing the time capsule in. The facility receives a date from the user when the time capsule is to be opened. The time capsule is not opened before the date given by the user. The owner of the time capsule is provided with a legal document with regards to the time capsule, the opening of the time capsule and the deed to the land where the time capsule is placed.

It is an object of the present invention for multiple time capsules to be placed in the sections of the facility. It is an object of the present invention for the time capsules to be stored underground or above ground. It is an object of the present invention for the time capsules to be part of a museum park.

It is an object of the present invention for the time capsules to be a unique, one-of-a-kind specifically manufactured to a user's specifications.

It is an object of the present invention for the time capsule to be transparent or translucent. It is an object of the present invention for the time capsule to be opaque.

It is an object of the present invention for the time capsules to be customized. It is an object of the present invention for the time capsules to be engraved pieces.

It is an object of the present invention for the time capsule to be in the shape of a heart. It is an object of the present invention for the time capsule to be in the shape of a peace drum. It is an object of the present invention for the time capsule to be in the shape of a sports piece such as a football. It is an object of the present invention for the time capsule to be in the shape of a book.

It is an object of the present invention for the time capsule to be in the shape of a game board.

It is an object of the present invention for the time capsule to be in the shape of a Rubix cube.

It is an object of the present invention for the time capsule to be in the shape of lips.

It is an object of the present invention for the time capsule to be in the shape of a shoe box.

It is an object of the present invention for designs to be placed on the outside of the time capsule.

It is an object of the present invention for there to be a security system provided to the time capsule park and/or personal museum.

It is an object of the present invention for the time capsule park to be subdivided into sections. It is an object of the present invention for a time capsule owner to be deeded a lot in the park for at least one time capsule. It is an object of the present invention for the user to be deeded the lot in perpetuity. It is an object of the present invention for the user to choose their own time capsule and design. It is an object of the present invention for the user to choose multiple time capsules for themselves, and family and friends. It is an object of the present invention for the system to allow a user to choose when their time capsule is to be opened. The time capsule cannot be opened before the date specified by the user. It is an object of the present invention to provide all of the information regarding the time capsules online. It is an object of the present invention to provide a password protected website for the owners of the Individual time capsules.

It is an object of the present invention to place cameras in the park to focus on specific time capsules.

It is an object of the present invention for each user to design there own time capsule.

It is an object of the present invention for the system to videotape and certify the contents of each time capsule, prior to sealing the time capsule. It is an object of the present invention to save the videotape of the time capsule until the time capsule is opened.

It is an object of the present invention to provide a user with a ceremony for sealing the time capsule.

It is an object of the present invention for there to be legal document with regards to the time capsule, it's opening and the deed to the land.

It is an object of the present invention for the time capsule to have a GPS.

It is an object of the present invention for the time capsule and/or the property that the time capsule is located on to be transferable to a third party, such as in a will.

It is an object of the present invention for the time capsules to be reusable.

It is an object of the present invention, that once the time capsules are sealed, they cannot be opened until the due date specified by the owner of the time capsule.

It is an object of the present invention for the time capsules to be stored under the ground.

It is an object of the present invention for the time capsules to be stored above the ground.

It is an object of the present invention for the time capsules to be part of a museum park.

It is an object of the present invention for the time capsules to not allow a person to see the contents inside.

It is an object of the present invention for the time capsule to allow a person to see the contents inside.

It is an object of the present invention to provide a system that tells the user and anyone specified by the user, how much time is left before the time capsule is opened.

It is an object of the present invention to provide a map to where each time capsule is located, and who owns each time capsule.

It is an object of the present invention to provide a ceremony when each time capsule is opened.

It is an object of the present invention to place digital data in the time capsule.

It is an object of the present invention to provide an audio device with the time capsule wherein one can store recorded sounds within the time capsule.

The present invention relates to a method for storing time capsules comprising: designing a time capsule for a user and storing information about the time capsule on a computer database. The Information comprises where the time capsule is located and the date when the time capsule is to be opened. The method further comprises providing a deed to a user for a section of land where the time capsule is placed. The land is subdivided into sections, where in each section contains one or more time capsules. The user provides a date when the time capsule is to be opened. The time capsules are placed either above ground or underground on the section of land owned by the user. It is an object of the present invention for the method to comprise certifying contents of time capsule prior to sealing said time capsule.

It is an object of the present invention for the time capsules to be made of 304 stainless steel with stainless steel bolting.

It is an object of the present invention that the organic contents of the sealed time capsule last for over 500 years. It is an object of the present invention to use hexamethylenetetriamine, argon gas vacuum pump and a vapor phase deacidification to preserve the contents of the time capsule.

It is an object of the present invention to create a personal museum to hold legacy items in an above ground structure designed to the users specifications allowing for a memorial or Important event. It is an object of the present invention for the personal museum to contain: pictures of a user's family; state of the art electronics; coins; watches; personal essays.

It is an object of the present invention to provide dry sealed chambers to hold time capsules or other legacy items. It is an object of the present invention for the museum to have quality glass doors so that visitors view all items in the museum.

It is an object of the present invention for the museums to be constructed in any size with various types of stone and metal specialties. It is an object of the present invention for the personal museums to be 12′×12′×10′ tall, but will be available in any size.

### BRIEF DESCRIPTION OF DRAWINGS

FIG. 1 shows a side view of two time capsules of the present invention.

FIG. 2 shows a top view of two time capsules of the present invention.

### DETAILED DESCRIPTION OF THE INVENTION

For example a person comes to the facility of the present invention. The person chooses a time capsule which is provided by the facility or has a personal time capsule made according to specifications that are provided to the facility. The person then chooses and is deeded a piece of land from the facility in which to store the time capsule. The facility has a security system to provide security for the time capsule. In a preferred embodiment, cameras are placed in the park that focus on Individual time capsules. The person chooses a time when the time capsule is to be opened. The time capsule cannot be opened prior to that date. The information regarding the time capsule is provided to the person online. The person is given a password protected website.

The facility stores and keeps information on the individual time capsules placed in the park. The facility videotapes and certifies the contents of the time capsule, prior to sealing the time capsule. The facility saves the videotape of the time capsule until the time capsule is opened. In a preferred embodiment, the facility provides a ceremony for sealing the time capsule. The facility provides a legal document with regards to the time capsule, it's opening and the deed to the land.

In a preferred embodiment, the time capsule has GPS.

The time capsules can either be stored under the ground or above the ground.

The time capsules are part of a museum park.

In an embodiment, the time capsules do not allow a person to see the contents inside. In an embodiment, the time capsule allows a person to see the contents inside.

The facility provides information to the user and anyone specified by the user, how much time is left before the time capsule is opened. The facility provides a map to where each time capsule is located, and who owns each time capsule. The facility provides a ceremony when each time capsule is opened.

In an embodiment digital data is placed in the time capsule.

In an embodiment, an audio device is provided with the time capsule wherein one can record sounds with the time capsule.

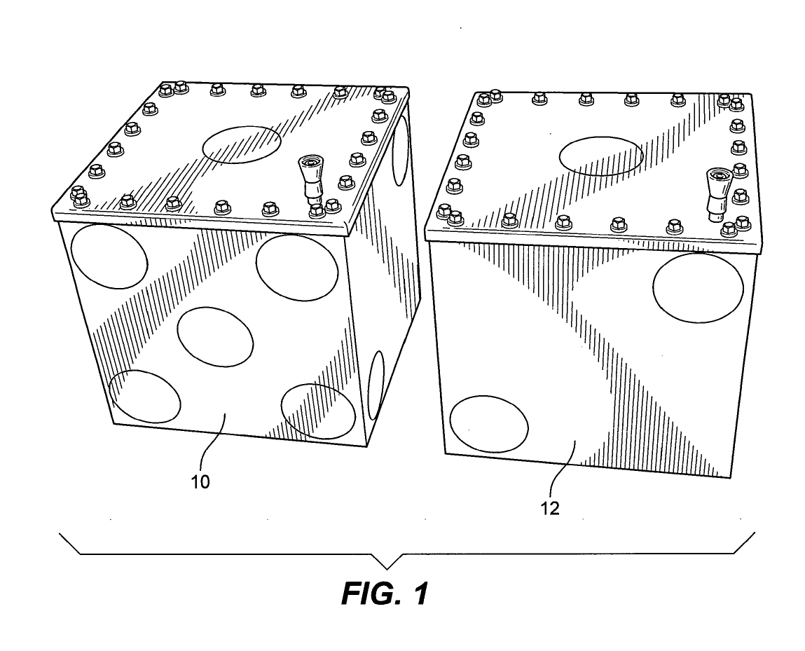

FIG. 1 shows two time capsules 10 and 12 of the present invention in the form of two dice.

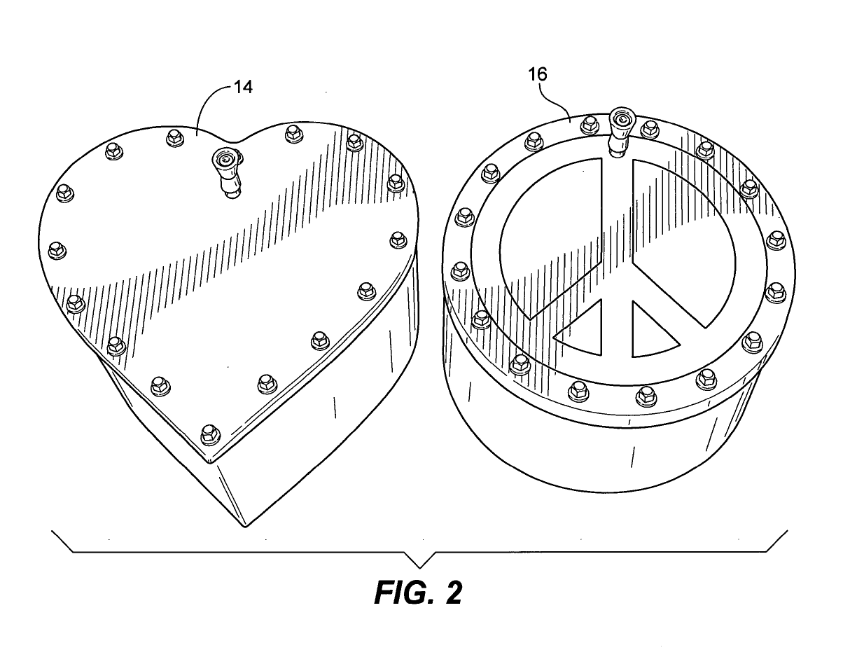

FIG. 2 shows two time capsules 14 and 16. Time capsule 14 is in the shape of a heart. time capsule 16 is in the shape of a peace drum.

1. A method for storing time capsules comprising:
designing a time capsule for a user;
storing information about said time capsule on a computer database;
said information comprising where said time capsule is located and date when said time capsule is to be opened;
providing a deed to a user for a section of land where said time capsule is placed;
subdividing said land into sections, where in each section contains one or more time capsules;
receiving a date from said user when said time capsule is to be opened;
placing said time capsules either above ground or underground on said section of land owned by said user.

2. The method of claim 1 further comprising certifying contents of time capsule prior to sealing said time capsule.
